(19) United States
(12) Patent Application Publication
(10) Pub. No.: US 2013/0197813 A1
(43) Pub. Date: Aug. 1, 2013

(54) SIMILARITY EVALUATING METHOD, SIMILARITY EVALUATING PROGRAM, AND SIMILARITY EVALUATING DEVICE FOR COLLECTIVE DATA

(71) Applicants: Yoshikazu Mori, Inashiki-gun (JP); Keiichi Noda, Inashiki-gun (JP)

(72) Inventors: Yoshikazu Mori, Inashiki-gun (JP); Keiichi Noda, Inashiki-gun (JP)

(73) Assignee: TSUMURA & CO., Minato-ku, Tokyo (JP)

(21) Appl. No.: 13/806,683

(22) PCT Filed: May 31, 2012
(86) PCT No.: PCT/JP2012/003612

§ 371 Date: Feb. 6, 2013

(30) Foreign Application Priority Data
Jun. 1, 2011 (JP) 2011-123847

(51) Int. Cl. G06F 19/00

(52) U.S. Cl. CPC G06F 19/707
USPC 702/22

(57) ABSTRACT

Provided is a similarity evaluating device for collective data to evaluate similarity between collective data sets in which a plurality of pieces of data are collected. The device includes a patterning part patterning each data of collective data with a selected scale, a matching number extraction part comparing each patterned data in a round-robin to find numbers of matches, and a matching degree determination part finding a degree of matching on the basis of the found numbers of matches with the use of Tanimoto coefficient, thereby evaluating similarity of the collective data simply and quickly.

### FIELD OF THE INVENTION

The present invention relates to a similarity evaluating method, a computer-readable storage medium storing a similarity evaluating program, and a similarity evaluating device for collective data.

### DESCRIPTION OF THE PRIOR ART

As multicomponent materials, for example, there are natural product-originated drugs such as kampo medicines that are drugs (hereinafter, referred to as multicomponent drugs) that are composed of multiple components. The quantitative and qualitative profiles of such drugs change due to a geological factor, an ecological factor, collecting season, a collecting area, a collecting aetas, weather during the growing period, and the like of raw material crude drugs.

Thus, for such multicomponent drugs and the like, predetermined criteria are regulated as qualities for securing the safety and the effectiveness thereof, and national supervising agencies, chemical organizations, manufacturing companies, and the like perform quality evaluations based on the criteria.

In general, however, the determination criteria on the quality and the like of a multicomponent drug are set based on the content and the like of one or several distinctive components selected from components in the multicomponent drug.

For example, in Non-Patent Literature 1, in a case where effective components of a multicomponent drug are not identified, it selects a plurality of components that have physical properties such as a quantitatively analyzability, high water-solubility, a undegradability in hot water, and non-chemical reactability with other components and uses the contents of the components acquired through chemical analysis as evaluation criteria.

In addition, it is well known to apply chromatography to a multicomponent drug, obtain an ultraviolet-visible absorption spectrum for each retention time, and set evaluation criteria based on sonic pieces of component information included therein.

For example, according to Patent Literature 1, some peaks included in HPLC chromatogram data (hereinafter, referred to as a chromatogram) are selected and encoded as barcodes, thereby evaluating a multicomponent drug.

However, in such methods, evaluation targets are limited to “contents of specific components” or “chromatogram peaks of specific components”, and thus only some components contained in a multicomponent drug are set as the evaluation targets. Accordingly, since a multicomponent drug includes many components other than components that are evaluation targets, such methods are insufficient as a method of evaluating a multicomponent drug in terms of accuracy.

In order to accurately evaluate the quality of a multicomponent drug, it is necessary to evaluate waveform patterns that cover the all the peak information or almost all peak information with the exclusion of small peaks corresponding to several %. Accordingly, it is necessary to associate all the peaks or almost all peaks with each other between multicomponent drugs.

However, it is difficult to efficiently associate a plurality of peaks with high accuracy. This interferes with an efficient evaluation of multicomponent drugs with high accuracy.

Described more, crude drugs are natural products, and therefore, multicomponent drugs, even which have the same product name, may have slightly different components. Hence, even if drugs have the same quality, content ratios of components thereof may be different from each other or a component present in one drug may not be present in the other drug (hereinafter, referred to as an inter-drug error), in addition, there is also a factor that peak intensity or peak elution time in a chromatogram has no precise reproducibility (hereinafter, referred to as an analysis error). Accordingly, all the peaks of or almost all peaks may not be associated with peaks that are originated from the same components between multicomponent drugs (hereinafter, referred to as peak assignment), thereby interfering with an efficient evaluation with high accuracy.

PATENT LITERATURE1: JP 2002-214215 A

NON-PATENT LITERATURE1: Pharmaceuticals monthly vol. 28, No. 3, pp 67 to 71 (1986)

### SUMMARY OF THE INVENTION

A problem to be solved is that there is a limit on an efficient evaluation of the quality and the like of multicomponent materials with high accuracy with use of an existing evaluating method.

In order to contribute to improvement of the accuracy and efficiency of the evaluation, the invention provides a similarity evaluating method evaluating similarity between collective data sets in which a plurality of pieces of data are collected (for example, measurement data (chart) such as liquid chromatogram (LC), gas chromatogram (GC) and nuclear magnetic resonance (NMR) spectrum, or data obtained by processing them such as patterning). The method comprises a patterning step of patterning each data of each collective data set with a selected scale, a matching number extraction step of comparing each patterned data in a round-robin to find numbers of matches, and a matching degree determination step of finding a degree of matching with use of Tanimoto coefficient on the basis of the found numbers of matches.

The invention provides a computer-readable storage medium storing a similarity evaluating program to evaluate similarity between collective data sets in which a plurality of pieces of data are collected, the program causing a computer to execute functions. The functions comprises a patterning step of patterning each data of each collective data set with a selected scale, a matching number extraction step of comparing each patterned data in a round-robin to find numbers of matches, and a matching degree determination step of finding a degree of matching with the use of Tanimoto coefficient on the basis of the found numbers of matches.

The invention provides a similarity evaluating device to evaluate similarity between collective data sets in which a plurality of pieces of data are collected, comprising a patterning part that patterns each data of each collective data set with a selected scale, a matching number extraction part that compares each patterned data in a round-robin to find numbers of matches, and a matching degree determination part that finds a degree of matching with the use of Tanimoto coefficient on the basis of the found numbers of matches.

The similarity evaluating method for collective data according to the invention has the above-identified configuration, so that it can simply and quickly evaluate similarity between collective data sets, in which a plurality of pieces of data are collected.

Consequently, for example, when comparing a target FP of a multicomponent material of an evaluation target with reference FPs of a plurality of drugs of evaluation criteria to evaluate it, the similarity evaluation method for collective data according to the invention makes it possible to perform simple and quick selection in selecting an FP of a multicomponent material suitable for peak assignment of the target FP from a plurality of reference FPs as a preprocessing thereof.

The storage medium storing the similarity evaluating program for collective data according to the invention has the above-identified configuration, so that it causes a computer to execute the functions to evaluate similarity between the FPs, thereby performing simple and quick selection of the reference FP and the like.

The similarity evaluating device for collective data according to the invention has the above-identified configuration, so that it operates each part to perform simple and quick selection of the reference FP and the like.

### BRIEF DESCRIPTION OF THE DRAWINGS

FIG. 1 is a block diagram of a similarity evaluating device for collective data according to Embodiment 1;

FIG. 2 is a process chart of a similarity evaluating method for collective data according to Embodiment 1;

FIG. 3 is graphs each illustrating a FP of a drug in which (A) is Drug A, (B) is Drug B and (C) is Drug C according to Embodiment 1;

FIG. 4 is an explanatory diagram illustrating retention time points of a target FP and a reference FP according to Embodiment 1;

FIG. 5 is an explanatory diagram illustrating a retention time appearance pattern of the target FP according to Embodiment 1;

FIG. 6 is an explanatory diagram illustrating a retention time appearance pattern of the reference FP according to Embodiment 1;

FIG. 7 is an explanatory diagram illustrating a number of matches in an appearance distance of the target FP and the reference FP according to Embodiment 1;

FIG. 8 is an explanatory diagram illustrating numbers of matches for all the retention time appearance distances of the target FP and the reference FP according to Embodiment 1;

FIG. 9 is an explanatory diagram illustrating degrees of matching for all the retention time appearance patterns of the target FP and the reference FP according to Embodiment 1;

FIG. 10 is an explanatory diagram illustrating a peak height ratio pattern of the target FP (Second embodiment)

FIG. 11 is a flowchart of data processes in the FP similarity evaluating process according to Embodiment 1; and

FIG. 12 is a flowchart of calculation process of the degree of matching between the retention time appearance patterns in the FP similarity evaluating process according to Embodiment 1.

### EMBODIMENTS FOR CARRYING OUT THE INVENTION

An object being to contribute to improvement of the accuracy and the efficiency of evaluation is accomplished by a patterning part, a matching number extraction part, and a matching degree determination part.

### Embodiment 1

Embodiment 1 of the invention applies a similarity evaluating device for collective data, for a preprocessing of an evaluating device for a multicomponent drug that evaluates multicomponent material, for example, a multicomponent drug.

A multicomponent drug is defined as a drug that contains a plurality of effective chemical components, and is not limited thereto, but includes a crude drug, a combination of crude drugs, an extract thereof, kampo medicines and the like. In addition, the dosage form is also not particularly limited, and includes, for example, a liquid, an extract, a capsule, a granule, a pill, a suspension emulsion, a powder, a spirit, a tablet, an infusion decoction, a tincture, a troche, aromatic water, a fluid extract and the like, which are prescribed under “General Rules for Preparations” in the Japanese Pharmacopoeia Fifteenth edition. The multicomponent material also includes those other than the drugs.

Specific examples of the kampo medicines are described in Industry Standard and Voluntarily Revision of “Precautions” in 148 Prescriptions for Medical Kampo Drug Formulation and in Guide to General Kampo Prescription (year 1978).

With the evaluating device for the multicomponent drug, first, it prepares a target FP, which is an extract of unique information from three-dimensional chromatogram data (hereinafter, referred to as 3D Chromatogram) of an evaluation target drug in order to evaluate whether or not the evaluation target drug is equivalent to a plurality of drugs defined as normal products. Next, a FP of a multicomponent drug suitable for peak assignment of the target FP is selected from among a plurality of reference FPs. To the peaks of this selected reference FP, respective peaks of the target FP is assigned.

And, each peak of the target FP assigned as described above is assigned to peak correspondence data of all reference FPs (hereinafter, referred to as the reference group FP) prepared by peak assignment process from all the reference FPs.

Next, the equivalency between peaks of the reference group FPs with the peaks of the assigned target FP (hereinafter, referred to as a target FP assignment peak) is evaluated with MT method. Finally, an acquired evaluation value (hereinafter, referred to as MD value) is compared with a preset determination value (the upper limit value of the MD value), to determine whether the evaluation target drug is equivalent to a normal product or not.

The 3D Chromatogram is a HPLC chromatogram data (hereinafter, referred to as chromatogram) of a kampo medicine as a multicomponent drug that is a multicomponent material as an evaluation target and that includes UV spectra.

An FP is finger print data composed of the maximum values or area values (hereinafter, referred to as peaks) in signal intensity (height) of peaks detected at a specific wavelength and appearance time points (hereinafter, retention time points) of the peaks.

A target FP is acquired by extracting a plurality of peaks, retention time points and UV spectra thereof at a specific detection wavelength from a 3D chromatogram that is three-dimensional chromatogram data of a kampo medicine being an evaluation target. Consequently, the target FP is collective data in which the peaks are collected as a plurality of pieces of data.

A reference FP is an FP of a kampo medicine as a multicomponent drug that is a multicomponent material defined as a normal product, and like the target FP, is acquired by extracting a plurality of peaks, retention time points and UV spectra thereof at a specific detection wavelength from a 3D chromatogram that is three-dimensional chromatogram data. Consequently, the reference FP is also collective data in which peaks are collected as a plurality of pieces of data.

### Similarity Evaluating Device and Similarity Evaluating Method for FPs

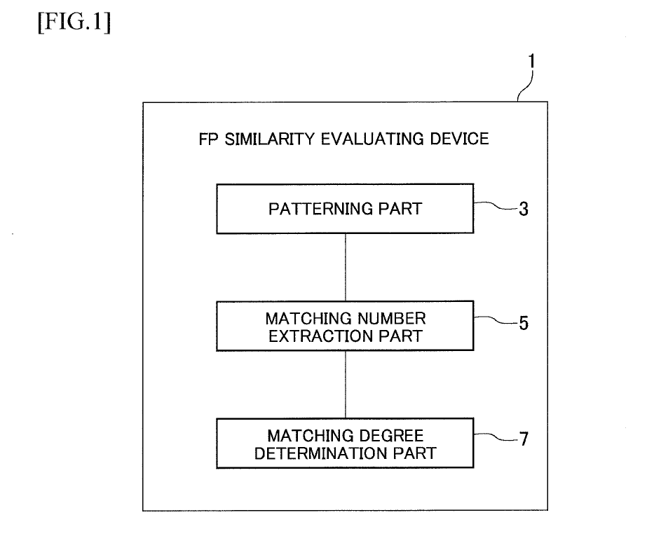

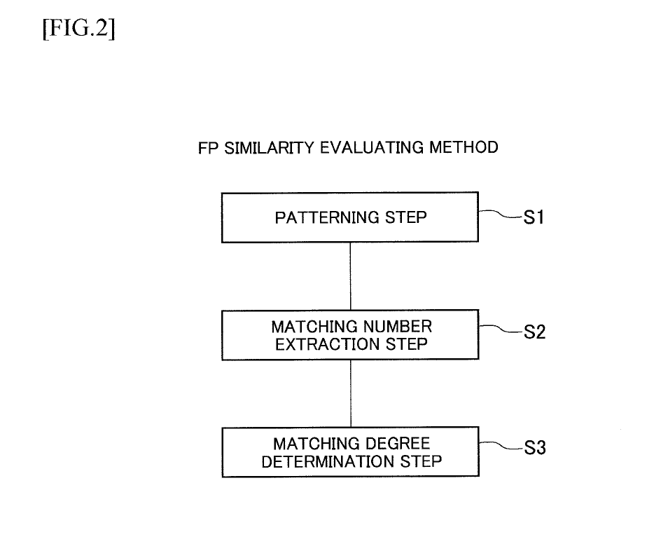

FIG. 1 is a block diagram of the similarity evaluating device for FPs and FIG. 2 is a process chart of the similarity evaluating method for FPs.

As illustrated in FIG. 1 and FIG. 2, the similarity evaluating method of FPs performed by functioning the similarity evaluating device 1 for FPs examines a degree of matching between the target FP and the reference FP.

The similarity evaluating device 1 for FPs is configured by a computer and has CPU, ROM, RAM and the like that are not illustrated. The similarity evaluating device 1 for FPs can implement the similarity evaluating program for collective data installed in a computer, to evaluate similarity of the target FR However, the similarity evaluation for the target FP may be realized by using a similarity evaluating program recording medium for collective data that stores the similarity evaluating program thereon by reading out it with the similarity evaluating device 1 for FPs configured by the computer.

The similarity evaluating method for FPs has a patterning step S1 performed by functioning a patterning part 3, a matching number extraction step S2 performed by functioning a matching number extraction part 5, and a matching degree determination step S3 performed by functioning a matching degree determination part 7.

In this similarity evaluating method for FPs, as preprocessing of the final evaluation, a FP of the multicomponent drug suitable for peak assignment of the target FP is selected from among the reference Hs as a plurality of collective data sets.

In the patterning step S1, each peak is each data of the target FP and the reference FP each being a collective data set, and is patterned with a selected scale by the function of the patterning part 3. This scale according to this embodiment is an inter-retention time distance as the appearance distance of the peaks. Specifically, it will be described below.

In the matching number extraction step S2, each patterned peak is compared in a round-robin, to find numbers of matches between respective patterns by the function of the matching number extraction part 5. These numbers of matches is numbers of matches in the appearance distance in this embodiment. Specifically, it will be described below.

In the matching degree determination step S3, a degree of matching between the respective patterns is found on the basis of the found numbers of matches with use of Tanimoto coefficient by the function of the matching degree determination part 7.

In the matching degree determination step S3, the degree of matching is found based on (1−Tanimoto coefficient) closer to zero in a situation of Tanimoto coefficient being set as:

“a number of matches in appearance distance/(a number of peaks of a target FP+a number of peaks of reference FP−the number of matches in appearance distance)”.

This (1−Tanimoto coefficient) may be weighted by (the number peaks of the target FP−the number of matches in appearance distance+1) to be converted into “(1−Tanimoto coefficient)×(the number peaks of the target FP−the number of matches in appearance distance+1)”,

With this weighting, it is possible to select a reference FP having peaks to which the peaks of the target FP matches more.

### Operation Principle of Similarity Evaluating Device and Similarity Evaluating Method for FPs

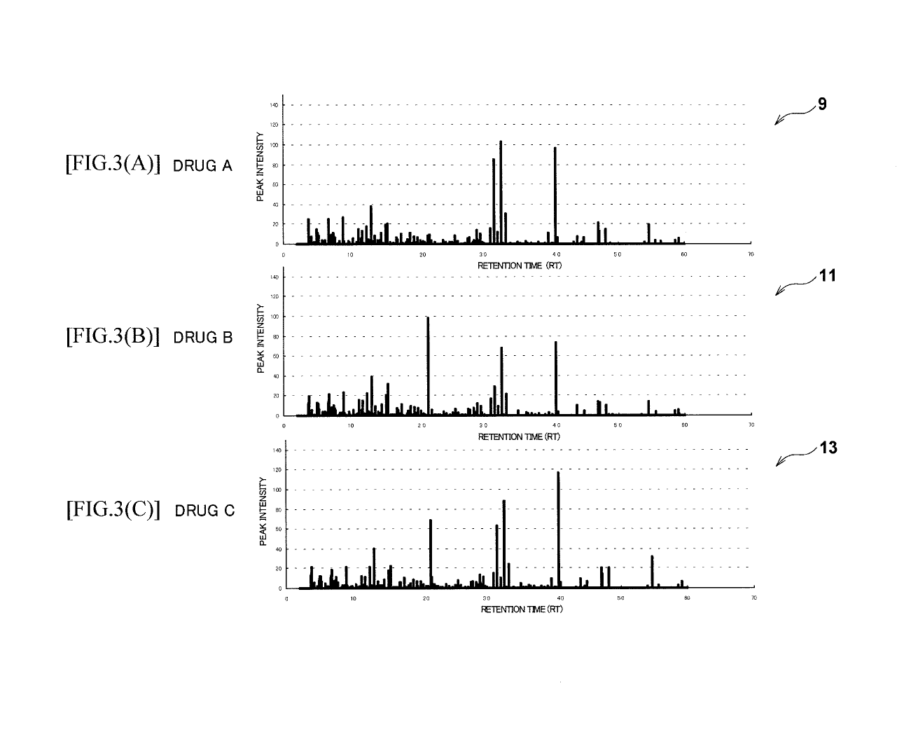

FIG. 3(A) illustrates a PP of Drug A, FIG. 3(B) illustrates a FP of Drug B, and FIG. 3(C) illustrates a FP of Drug C.

For example, if the FP of Drug A is the target FP and the FPs of Drugs B and C are the reference FPs, before each peak of the target FP is assigned to the reference group FPs prepared from Drugs B and C, a reference PP of any one of Drugs B and C suitable tor assignment of the target FP is selected from among a plurality of reference FPs, to assign each peak of the target FP to a peak of this selected reference FP.

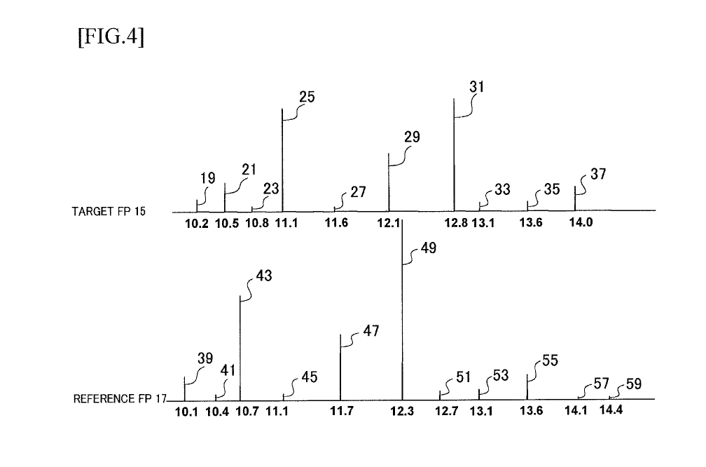

That is, in order to perform the peak assignment of each peak of the target FP with high accuracy, the degrees of matching between the target FP and the reference FPs in the peak retention time appearance pattern are calculated to select a reference FP having the minimum degree of matching from among all the reference FPs as illustrated in FIG. 4 to FIG. 9.

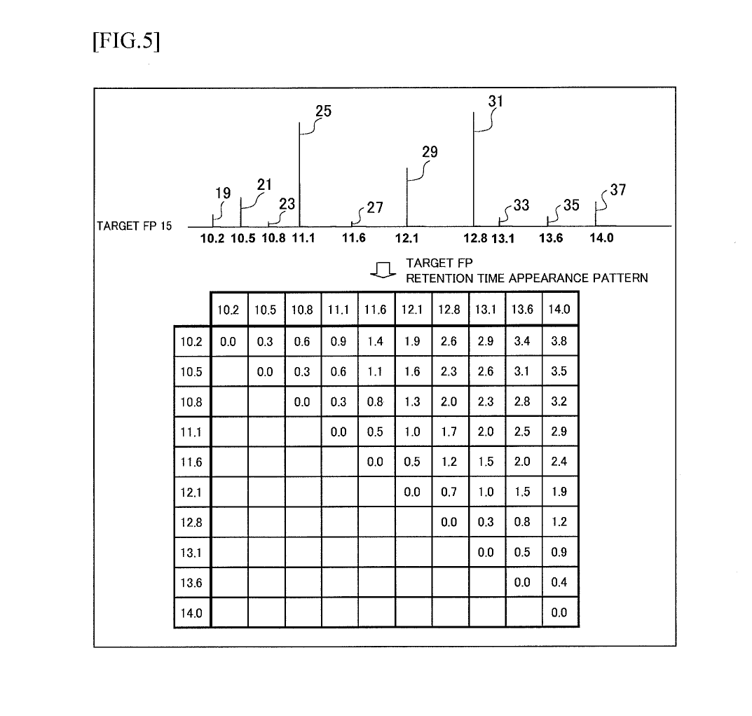

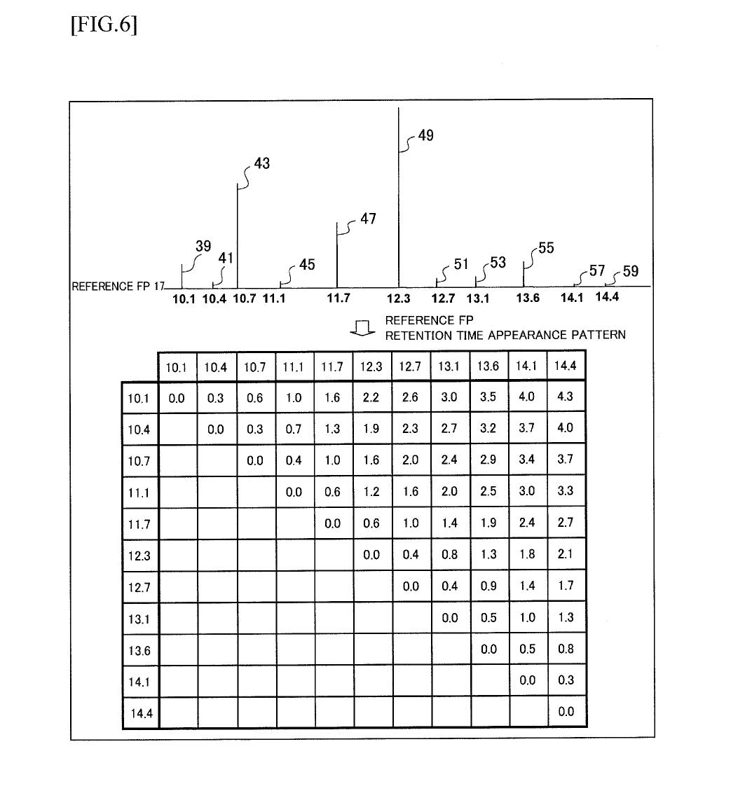

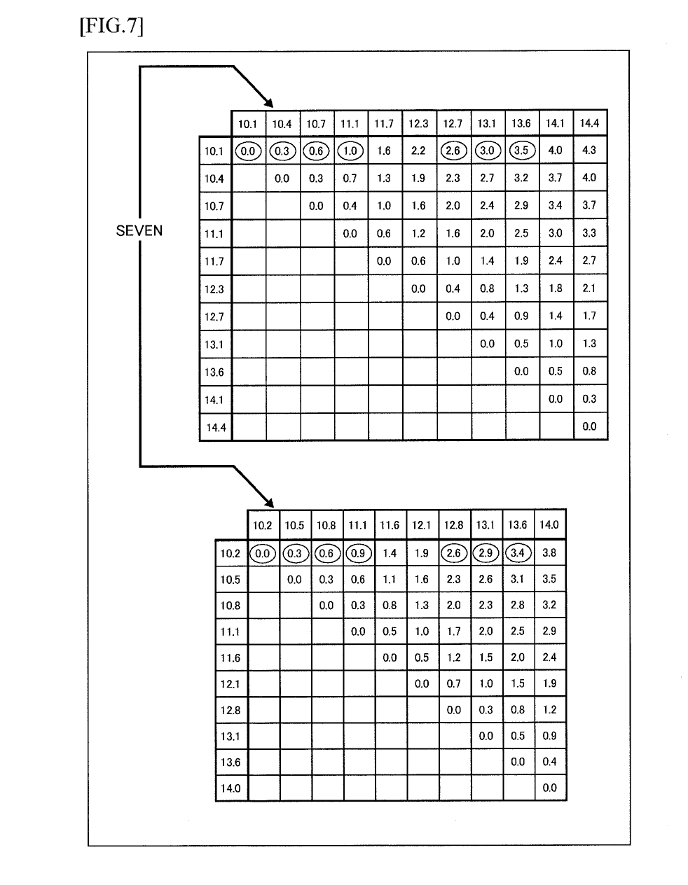

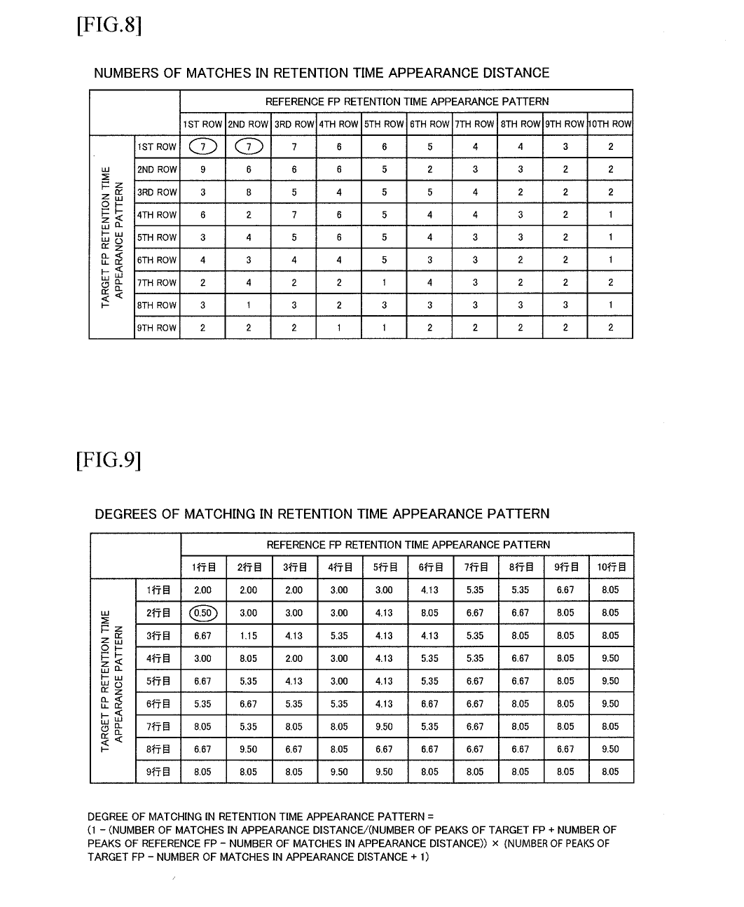

FIG. 4 to FIG. 9 are diagrams that explain the number of matches in the retention time appearance distance or the degree of matching in the retention time appearance pattern between the target FP and the reference FPs. FIG. 4 is an explanatory diagram illustrating the retention time points of the target FP and the reference FP, FIG. 5 is an explanatory diagram illustrating the retention time appearance pattern of the target FP, and FIG. 6 is an explanatory diagram illustrating the retention time appearance pattern of the reference FP. FIG. 7 is an explanatory diagram illustrating the number of matches in the appearance distance between the target and the reference FPs, FIG. 8 is an explanatory diagram illustrating the number of matches of all the retention time appearance distances of the target FP and the reference FP, and FIG. 9 is an explanatory diagram illustrating the degrees of matching of all the retention time appearance patterns of the target FP and the reference FP.

FIG. 4 shows the retention time point of each of the target FP 15 and the reference FP 17. FIG. 5 and FIG. 6 show the retention time appearance patterns in which calculated are all the inter-retention time point distances from each retention time point of the target FP 15 and the reference FP 17 and are summarized in the form of a table. FIG. 7 shows the number of matches in the retention time appearance distance, which is obtained by comparing the values of the retention time appearance patterns of the target FP and the reference FPs in each cell in each row and by counting and calculating a number of which a difference between the two values is within a predetermined range. FIG. 8 shows the numbers of matches in the retention time appearance distance in the form of a table, which are calculated in all combinations of the target FP and the reference FP. FIG. 9 shows the degree of matching between the retention time appearance patterns in the form of a table, which is calculated based on these numbers of matches.

In the peak assignment process of the target FP 15, each peak of the target FP 15 is assigned to a reference FP that is similar to the target FP 15 in the FP pattern as much as possible. It is an important point to select a reference FP that is similar to this target FP 15 from among a plurality of reference FPs in performing the assignment with high accuracy.

Then, as a method of objectively and simply evaluating similarity with respect to the FP pattern of the target FP 15, the similarity in the FP pattern is evaluated according to the degree of matching in the retention time appearance pattern.

For example, in a case where the retention time points of the target FP 15 and the reference FP 17 are illustrated in FIG. 4, the retention time appearance pattern of each of the target FP 15 and the reference FP 17 are as illustrated in FIG. 5 and FIG. 6, respectively. In FIG. 5 and FIG. 6, the target FP 15 and the reference FP 17 in the upper side are patterned and prepared in the form of a table in which value of each cell is an inter-retention time point distance as illustrated in the lower side.

In FIG. 5, the retention time points of respective peaks (19, 21, 23, 25, 27, 29, 31, 33, 35 and 37) of the target FP 15 are (10.2), (10.5), (10.8), (11.1), (11.6), (12.1), (12.8), (13.1), (13.6) and (14.0).

Accordingly, the inter-retention time point distance between the peak 19 and the peak 21 is (10.5)−(10.2)=(0.3). Similarly, the inter-retention time point distance between the peak 19 and the peak 23 is (0.6), and the inter-retention time point distance between the peak 21 and the peak 23 is (0.3), and the like. The followings are similar, and the target FP appearance pattern are acquired as illustrated in the lower side of FIG.

In FIG. 6, the retention time points of respective peaks (39, 41, 43, 45, 47, 49, 51, 53, 55, 57, and 59) of the reference FP 17 are (10.1), (10,4), (10.7), (11.1), (11.7), (12.3), (12.7), (13.1), (13.6), (14.1) and (14.4),

Accordingly, similarly, the inter-retention time point distances are translated into the reference FP appearance pattern as illustrated in the lower side of FIG. 6.

Each peak patterned in FIG. 5 and FIG. 6 is compared in a round-robin to find the numbers of matches. For example, the value of the target FP appearance pattern in each cell of the lower side of FIG. 5 is compared with the value of the reference FP appearance pattern in each cell of the lower side of FIG. 6 as illustrated in FIG. 7, and the numbers of matches are obtained as illustrated in FIG. 8.

In FIG. 7, the patterns according to all the inter-retention time point distance of the retention time appearance patterns of the target FP 15 and the reference FP 17 are compared in a round-robin in sequence on a per-row basis, to calculate the numbers of distances matching within a set range,

For example, when comparing the patterns at the first rows of the target and reference FP retention time appearance patterns of FIG. 7 with each other, circled numerical values match to each other and the number of matches is seven. This matching number of seven is written into a cell for the first rows of the target and reference FP retention time appearance patterns of FIG. 8 as the number of matches in the retention time appearance distance. The same applies to the other rows in FIG. 7, and the 1st to 9th rows of the target FP retention time appearance patterns are compared with the 1st to 10th rows of the reference FP retention time appearance patterns in a round-robin., and the numbers of matches are obtained, respectively.

The results are illustrated in FIG. 8. In FIG. 8, the circled leftmost numerical value of “7” is a result of comparison of the first rows of the respective target and reference FP retention time appearance patterns, and the next numerical value of 7 is a result of comparison of the first row of the target FP retention time appearance pattern with the second row of the reference FP retention time appearance pattern,

In addition, the range of the set value is preferably orange from 0.05 minutes to 0.2 minutes in order to determine the matching of the appearance distances, but is not limited thereto. According to Embodiment 1, the set value is 0.1 minutes.

When the degree of matching between the retention time appearance patterns is indicated as RP, the degree of matching (RP_{fg}) between a retention time appearance pattern at the f-th row of the target FP 15 and a retention time appearance pattern at the g-th row of the reference FP 17 is calculated with use of Tanimoto coefficient as:

RP_{fg}={1=(m/(a+b−m))}×(a−m30 1).

In the equation, “a” is the number of the peaks of the target FP 15 (target FP peak number), “b” is the number of the peaks of the reference FP 17 (reference FP peak number), and “m” is the number of matches in the retention time appearance distance (FIG. 8).

The degrees of matching for each retention time appearance pattern (RP) is calculated by the equation based on the numbers of matches in FIG. 8 (FIG. 9).

RP_min is the minimum value of these RPs and is set as the degree of matching between the retention time appearance patterns of the target FP 15 and the reference FP 17. In FIG. 9, (0.50) is the degree of matching between the target FP 15 and the reference FP.

Such degree of matching is calculated for all the reference FPs, the reference FP having the minimum degree of matching is selected, and the peak assignment of the target FP to this reference FP is performed.

### Similarity Evaluating Program

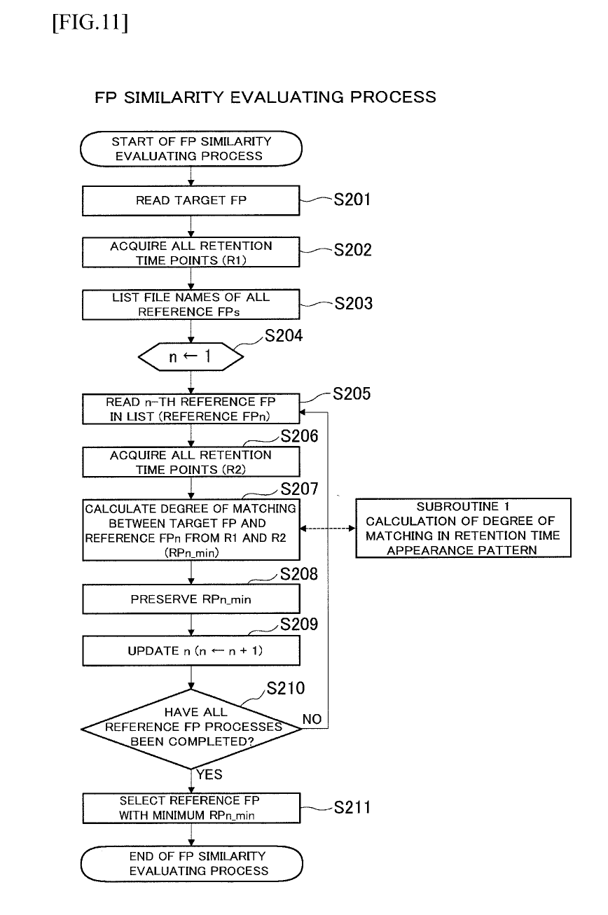

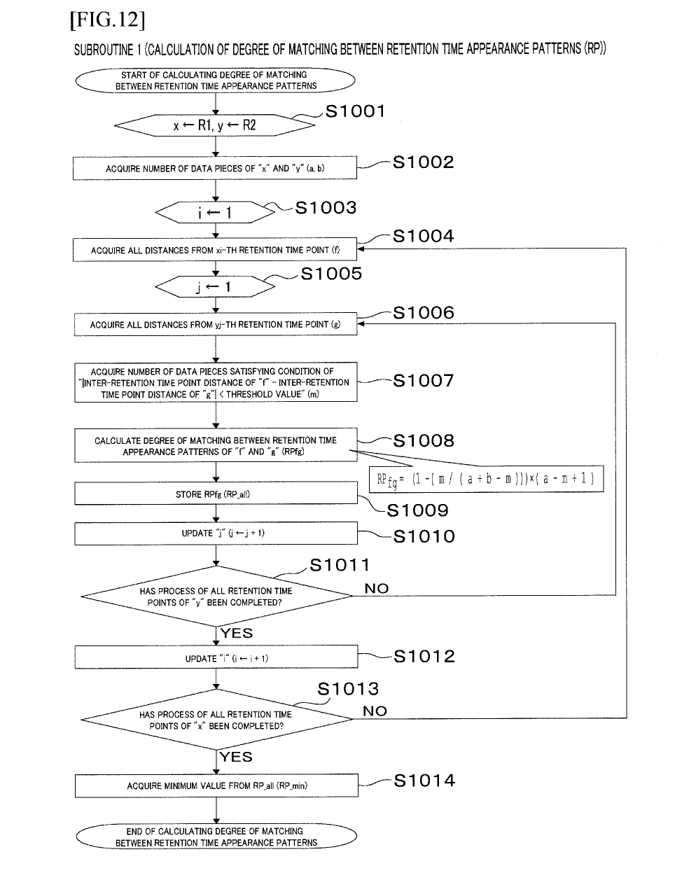

FIGS. 11 and 12 are flowcharts according to the similarity evaluating program.

FIG. 11 is a flowchart illustrating steps of a whole process fir evaluating similarity between FPs, wherein the process starts with a system start-up to cause the computer to execute the patterning function, the matching number extraction function, and the matching degree determination function, thereby evaluating the similarity of the retention time appearance patterns between the target FP 17 and a plurality of reference FPs defined as normal products to select a reference FP suitable for assignment of the target FP 17.

FIG. 12 is a flowchart illustrating details of the “Subroutine 1” in the “FP similarity evaluating process” of FIG. 11. This process calculates the degree of matching between the retention time appearance patterns of FPs (for example, the target FP and the reference FP).

### FP Similarity Evaluating Process

In Step S201, a process of “reading target FP” is executed. This process reads a FP of an assignment target, and the procedure proceeds to Step S202.

In Step S202, a process of “acquiring all retention time points (R1)” is executed. This process acquires all the retention time point information of the target FP read in S201, and the procedure proceeds to Step S203.

In Step S203, a process of “listing file names of all reference FPs” is executed. This process, in order to process all the reference FPs in sequence later, lists file names of all the reference FPs in advance, and the procedure proceeds to Step S204.

In Step S204, as an initial value of a counter for processing the total reference FPs in sequence, “1” is substituted into “n” (n←1), and the procedure proceeds to Step S205.

In Step S205, a process of “reading an n-th reference FP in the list (reference FPₙ)” is executed. At this process, the n-th FP of the file name list of all the reference FPs listed in S203 is read, and the procedure proceeds to Step S206.

In Step S206, a process of “acquiring all retention time points (R2)” is executed. At this process, all the retention time point information of the reference FP read in S205 is acquired totally, and the procedure proceeds to Step S207.

In Step S207, a process of “calculating the degree of matching between retention time appearance patterns of R1 and R2 (RPₙ_{_{—}}min)” is executed. At this process, RPₙ_{_{—}}min is calculated from the retention time points of the target FP acquired in S202 and the retention time points of the reference FP acquired in S206, and the procedure proceeds to Step S208. In addition, detailed calculation flows of RPₙ_{_{—}}min are explained separately by the subroutine 1 in FIG. 12.

In Step S208, a process of “preserving RPₙ_{_{—}}min (RPₐₗₗ_{_{—}}min)” is executed. At this process, RPₙ_{_{—min}} calculated in 5207 is preserved in RPₐₗₗ_{_{—}}min, and the procedure proceeds to Step S209.

In Step S209, a process of “updating n (n←n+1)” is executed. At this process, “n+1” is substituted for “a” as the update of “n” to advance the process to the next FP, and the procedure proceeds to Step S210.

In Step S210, a determining process “Have all reference FP processes been completed?” is executed. At this process, it is determined whether all of the reference FPs are processed or not. If processed (YES), the procedure proceeds to Step S211. If there are one or more unprocessed reference FPs (NO), the procedure proceeds to S205 in order to execute the processes of S205 to S210 regarding unprocessed FPs, The processes of S205 to S210 are repeated until the processes of all the reference FPs are completed.

In Step S211, a process of “selecting a reference FP demonstrating the minimum degree of matching from RPₐₗₗ_{_{—}}min” is executed. At this process, RP₁_{_{—}}min up to RPₙ_{_{—}}min calculated for all the reference FPs are compared with each other to select a reference FP demonstrating the minimum degree of matching with respect to the retention time appearance pattern of the target FP.

### Subroutine 1

In Step S1001, a process of “x←R1 , y←R2” is executed. At this process, R1 and R2 acquired in S202 and S206 of FIG. 11 are respectively substituted into “x” and “y”, and the procedure proceeds to Step S1002.

In Step S1002, a process of “acquiring numbers of data of “x” and “y” (a, b)” is executed. At this process, the numbers of data pieces of “x” and “y” are respectively acquired as “a” and “b”, and the procedure proceeds to Step S1003.

In Step S1003, “1” is substituted into “i” (i←1) as the initial value of a counter for sequentially invoking the retention time points of “x”, and the procedure proceeds to Step S1004.

In Step S1004, a process of “acquiring all distances from the xi-th retention time point (f)” is performed. In this process, all distances, from the xi-th retention time point, of retention time points after the xi-th retention time point are acquired as “f”, and the procedure proceeds to Step S1005.

In Step S1005, “1” is substituted into “j” (j←1) as the initial value of a counter for sequentially invoking the retention time points of “y”, and the procedure proceeds to Step S1006.

In Step S1006, a process of “acquiring all distances from the yj-th retention time point (g)” is performed. In this process, all distances, from the yj-th retention time point, of retention time points after the yj-th retention time point are acquired as “g”, and the procedure proceeds to Step S1007.

In Step S1007, a process of “acquiring the number of data pieces satisfying a relation of “|inter-retention time point distance of “f”−inter-retention time point distance of “g”|<threshold value” (m)” is performed. In this process, an inter-retention time point distances “f” and “g” acquired in Steps S1004 and S1006 are compared with each other in a round-robin, the number of data pieces satisfying the condition of “|inter-retention time point distance of “f”−inter-retention time point distance of “g”|<threshold value” is acquired as “m”, and the procedure proceeds to Step S1008.

In Step S1008, a process of “calculating the degree of matching between the retention time appearance patterns of “f” and “g” (RP_{fg})” is performed in this process, RP_{fg} is calculated based on “a” and “h” acquired in Step S1002 and “m” acquired in Step S1007 as:

RP_{fg}=(1−(m/(a+b−m)))×(a−m+1).

Then, the procedure proceeds to Step S1009.

In Step S1009, a process of “preserving RP_{fg}(RP _all)” is executed. At this process, the degree of matching calculated in S1008 is preserved to RP_all, and the procedure proceeds to Step S1010.

In Step S1010, a process of “updating “j” (j←j+1)” is executed, At this process, “j+1” is substituted into “j” as the update of “j” in order to advance the process of “y” to the next retention time point, and the procedure proceeds to Step S1011.

In Step S1011, a determining process “Has the process been completed at all the retention time points of “y”?” is executed. In this process, it is determined whether or not the process for all the retention time points of “y” has been completed, if completed (YES), it is determined that the process for all the retention time points has been completed to proceed to Step S1012. If not completed (NO), it is determined that one or more retention time points that have not been processed remain in “y”, to proceed to Step S1006. In other words, the processes of Steps S1006 to S1011 are repeated until all the retention time points of “y” are processed.

In Step S1012, a process of “updating “i” (i←i+1)” is executed. At this process, “i+1” is substituted into “i” as the update of “i” in order to advance the process of “x” to the next retention time point, and the procedure proceeds to Step S1013.

In Step S1013, a determining process “Has the process been completed at all the retention time points of “x”?” is executed. In this process, it is determined whether or not the process for all the retention time points of “x” has been completed. If completed (YES), it is determined that the process for all the retention time points of “x” has been completed to proceed to Step S1014, if not completed (NO), it is determined that one ore more retention time points that have not been processed remain in “x”, to proceed to Step S1004, in other words, the processes of Steps S1004 to S1013 are repeated until all the retention time points of “x” are processed.

In Step S1014, a process of “acquiring a minimum value from RP all (RP_min)” is performed. In this process, the minimum value in RP all in which RPs for all the combinations of the retention time appearance patterns of the target FP and the reference FP are stored is acquired as RP_min, and RP_min is input to Step S207 of FIG. 11 to finish the process of calculating the degree of matching between the retention time appearance patterns.

### Effects of Embodiment 1

Embodiment 1 of the invention is the similarity evaluating method for a FP to evaluate similarity between the target FP 15 and the reference FP 17, in which a plurality of peaks (19, 21, . . . ) and (39, 41, . . . ) are collected. The method includes the patterning step S1 of patterning each of the peaks (19, 21, . . . ) and (39, 41, . . . ) of the target FP 15 and the reference FP 17 with the appearance distance as illustrated in FIGS. 5 and 6, the matching number extraction step S2 of comparing each patterned pattern in a round-robin to find the numbers of matches as illustrated in FIG. 8, and the matching degree determination step S3 of finding the degree of matching as illustrated in FIG. 9 with the use of Tanimoto coefficient on the basis of the found numbers of matches.

Consequently, it is possible to evaluate similarity between the target FP 15 and the reference FP 17 simply and quickly, thereby assigning each peak of the target FP 15 to the reference FP that is similar to the target FP 15 in the FP pattern as much as possible. It is possible to select a reference FP that is similar to this target FP 15 from a plurality of reference FPs, thereby performing the assignment with higher accuracy.

In the matching deuce determination step S3, the Tanimoto coefficient is set as “a number of matches in an appearance distance/(a number of peaks of a target FP+a number of peaks of a reference FP−the number of matches in the appearance distance)” to find the degree of matching with (1−Tanimoto coefficient) closer to zero, The (1−Tanimoto coefficient) is weighted by (the number of peaks of the target FP−the number of matches in the appearance distance+1) to be converted into “(1−Tanimoto coefficient)×(the number of peaks of the target FP−the number of matches in the appearance distance+1)”, thereby finding the degree of matching.

Accordingly, it is possible to select a reference FP that matches more to the peaks (19, 21, . . . ) of the target FP 15 due to the weighting.

The similarity evaluation program for collective data according to Embodiment 1 of the present invention can evaluate similarity between FPs by executing the patterning function, the matching number extraction function, and the matching degree determination function, thereby simply and quickly performing selection of the reference FP.

According to the similarity evaluating device 1 of FPs of Embodiment I of the invention, it is possible to realize the similarity evaluating method for FPs by the patterning part 3, the matching number extraction part 5, and the matching degree determination part 7.

### Embodiment 2

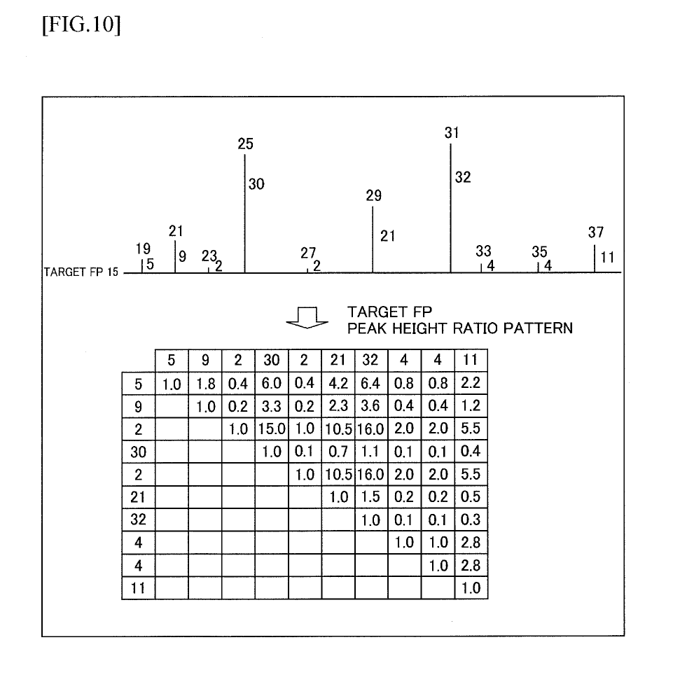

FIG. 10 is an explanatory diagram illustrating a peak height ratio pattern of a target FP.

In Embodiment 2, the target FP 15 in the upper side of FIG. 10 is patterned in the form of a table in which value of each cell is a peak height ratio as illustrated in the lower side.

In FIG. 10, the peak heights of respective peaks (19, 2.1, 23, 25, 27, 29, 31, 33, 35, 37) of the target FP 15 are (5, 9, 2, 30, 2, 21, 32, 4, 4, 11).

Therefore, the height ratio between the peak 19 and the peak 21 is (9+5)=(1.8). Similarly, the height ratio between the peak 19 and the peak 23 is (0.4), the height ratio between the peak 21 and the peak 23 is (0.2), and the like. The followings are similar, and the height ratio pattern of the target FP is acquired as illustrated in the lower side of FIG. 10.

Also for the reference FPs, the height ratio patterns of the peaks of the reference FPs are acquired similarly.

Therefore, in Embodiment 2, the patterning step S1 performs patterning with the height ratio for the peaks as a scale.

In the matching number extraction step S2, the number of matches in the height ratio is set as the matching number, and each patterned peak with the height ratio of the peak is compared in a round-robin, to calculate the number of the height ratio matching within a set range. From this calculation, it is possible to obtain the matching number similarly to FIG. 8.

In addition, this embodiment of patterning with the height ratio of the peak may have a plurality of identical values in a single row illustrated in the lower side of FIG. 10 and there is a need not to count these values a plurality of times.

The matching degree determination step S2 sets the Tanimoto coefficient as “a number of matches in height ratio/(a number of peaks of a target FP+a number of peaks of a reference FP−the number of matches in the height ratio)” to find the degree of matching with (1−Tanimoto coefficient) closer to zero.

Further, the (1−Tanimoto coefficient) is weighted by (the number of peaks of the target FP−the number of matches in the height ratio+1) to be converted into “(1−Tanimoto coefficient)×(the number of peaks of the target FP−the number of matches in the height ratio+1)”, to select a reference FP that matches more to the peaks (19, 21, . . . ) of the target FP 15 due to the weighting.

Therefore, Embodiment 2 can provide similar effects to those of Embodiment 1.

Although the embodiments of the present invention are applied to evaluation of the kampo medicine as a multicomponent drug, the present invention may be applied to evaluation of other multicomponent materials. The chromatogram is not limited to the 3D chromatogram, and a FP may be used as what composed of peaks with the exclusion of UV spectra and of retention time points thereof.

The similarity evaluation method for collective data according to the present invention is a similarity evaluating method to examine the degree of matching between collective data sets in which a plurality of pieces of data are collected. The similarity evaluation method includes a patterning step of patterning each data of each collective data set with a selected scale, a matching number extraction step of comparing each patterned data in a round-robin to find numbers of matches, and a matching degree determination step of finding a degree of matching with use of Tanimoto coefficient on the basis of the found numbers of matches, thereby being broadly applied to evaluation of similarity between collective data sets. The collective data set is not limited to a FP, and be also applied to other signal data and the like.

The FP as the collective data set of the aforementioned embodiments is prepared on the basis of the peak heights, to be evaluated similarity by the aforementioned method. However, even when a FP is prepared with area values of peaks, the FP can be evaluated in the same way.

That is, peaks used in the similarity evaluating method, the similarity evaluating program and the similarity evaluating device for collective data according to the present invention encompasses a case where a peak means the maximum value of signal intensity (height) as described above and also a case where a peak means an area value of signal intensity (peak area) is expressed as the height.

In this case, even when a FP is prepared with the peak areas, the FP is prepared by expressing the peak areas as heights. As the FP, it is a similar expression to the case where the FP is prepared with the peak heights of the aforementioned embodiment. Consequently, even if the FP is prepared with the peak areas, it is possible to evaluate similarity by the process of the aforementioned Embodiment 1 or Embodiment 2 in the same way as a case where the FP is prepared with the peak heights of signal intensity.

Therefore, in the invention, the patterning part, the patterning step, and the patterning function can process in the same way as Embodiment 2 with use of area ratio of the peak area as a scale in which each data of each collective data set is selected other than the peak appearance distance of Embodiment 1.

1. A similarity evaluating method for collective data to evaluate similarity between collective data sets in which a plurality of pieces of data are collected, the method comprising:
a patterning step of patterning each data of each collective data set with a selected scale;
a matching number extraction step of comparing each patterned data in a round-robin to find numbers of matches; and
a matching degree determination step of finding a degree of matching with use of Tanimoto coefficient on the basis of the found numbers of matches.

2. The method according to claim 1, wherein
the collective data is a FP composed of peaks and retention time points thereof,
the patterning step takes any one of appearance distance, height ratio and area ratio of a peak as the scale,
in a case where a reference FP being most similar to a target FP is selected from plural kinds of reference FPs according to the degree of matching,
the matching number extraction step sets numbers of matches in any one of the appearance distance, the height ratio and the area ratio as the numbers of matches, and
the matching degree determination step sets the Tanimoto coefficient as “a number of matches in any one of appearance distance, height ratio and area ratio/(a number of peaks of a target FP+a number of peaks of a reference FP−the number of matches in any one of appearance distance, height ratio and area ratio)” to find the degree of matching with (1−Tanimoto coefficient) closer to zero.

3. The method according to claim 2, wherein
the (1−Tanimoto coefficient) is weighted by (the number of peaks of target FP−the number of matches in any one of appearance distance, height ratio and area ratio+1) to be converted into “(1−Tanimoto coefficient)′(the number of peaks of target FP−the number of matches in any one of appearance distance, height ratio and area ratio+1)”.

4. The method according to claim 2, wherein
the FP is detected from a chromatogram of a multicomponent material.

5. The method according to claim 4, wherein
the multicomponent material is a multicomponent drug.

6. The method according to claim 5, wherein
the multicomponent drug is any one of a crude drug, a combination of crude drugs, an extract thereof, and a kampo medicine.

7. A computer-readable storage medium storing a similarity evaluating program for collective data to evaluate similarity between collective data sets in which a plurality of pieces of data are collected, the program causing a computer to execute functions comprising:
a patterning function of patterning each data of each collective data set with a selected scale;
a matching number extraction function of comparing each patterned data in a round-robin to find numbers of matches; and
a matching degree determination function of finding a degree of matching with the use of Tanimoto coefficient on the basis of the found numbers of matches.

8. The program computer-readable storage medium according to claim 7, wherein
the collective data is a FP composed of peaks and retention time points thereof,
the patterning function takes any one of appearance distance, height ratio and area ratio of a peak as the scale,
in a case where a reference FP being most similar to a target FP is selected from plural kinds of reference FPs according to the degree of matching,
the matching number extraction function sets numbers of matches in any one of the appearance distance, the height ratio and the area ratio as the numbers of matches, and
the matching degree determination function sets the Tanimoto coefficient as “a number of matches in any one of appearance distance, height ratio and area ratio/(a number of peaks of a target FP+a number of peaks of a reference FP−the number of matches in any one of appearance distance, height ratio and area ratio)” to find the degree of matching with (1−Tanimoto coefficient) closer to zero.

9. The computer-readable storage medium according to claim 8, wherein
the (1−Tanimoto coefficient) is weighted by (the number of peaks of target FP−the number of matches in any one of appearance distance, height ratio and area ratio+1) to be converted into “(1−Tanimoto coefficient)′(the number of peaks of target FP−the number of matches in any one of appearance distance, height ratio and area ratio+1)”.

10. The computer-readable storage medium according to claim 8, wherein
the FP is detected from a chromatogram of a multicomponent material.

11. The computer-readable storage medium according to claim 10, wherein
the multicomponent material is a multicomponent drug.

12. The computer-readable storage medium according to claim 11, wherein
the multicomponent drug is any one of a crude drug, a combination of crude drugs, an extract thereof, and a kampo medicine.

13. A similarity evaluating device to evaluate similarity between collective data sets in which a plurality of pieces of data are collected, the device comprising;
a patterning part patterning each data of each collective data set with a selected scale;
a matching number extraction part comparing each patterned data in a round-robin to find numbers of matches; and
a matching degree determination part finding a degree of matching with use of Tanimoto coefficient on the basis of the found numbers of matches.

14. The device according to claim 13, wherein
the collective data is a FP composed of peaks and retention time points thereof,
the patterning part takes any one of appearance distance, height ratio and area ratio of a peak as the scale,
in a case where a reference FP being most similar to a target FP is selected from plural kinds of reference FPs according to the degree of matching,
the matching number extraction part sets numbers of matches in any one of the appearance distance, the height ratio and the area ratio as the numbers of matches, and
the matching degree determination part sets the Tanimoto coefficient as “a number of matches in any one of appearance distance, height ratio and area ratio/(a number of peaks of a target FP+a number of peaks of a reference FP−the number of matches in any one of appearance distance, height ratio and area ratio)” to find the degree of matching with (1−Tanimoto coefficient) closer to zero.

15. The device according to claim 14, wherein
the (1−Tanimoto coefficient) is weighted by (the number of peaks of target FP−the number of matches in any one of appearance distance, height ratio and area ratio+1) to be converted into “(1−Tanimoto coefficient)′(the number of peaks of target FP−the number of matches in any one of appearance distance, height ratio and area ratio+1)”.

16. The device according to claim 1, wherein
the FP is detected from a chromatogram of a multicomponent material.

17. The device according to claim 16, wherein
the multicomponent material is a multicomponent drug.

18. The device according to claim 17, wherein
the multicomponent drug is any one of a crude drug, a combination of crude drugs, an extract thereof, and a kampo medicine.
